(19) United States
(12) Patent Application Publication
(10) Pub. No.: US 2009/0164786 A1
(43) Pub. Date: Jun. 25, 2009

(54) CONTENT DELIVERY METHOD, CONTROL TERMINAL, AND DISPLAY TERMINAL

(76) Inventors: Nobuhiro SEKIMOTO, Tachikawa (JP); Hideki Kamimaki, Fujisawa (JP)

Correspondence Address: MATTINGLY & MALUR, P.C., 1800 DIAGONAL ROAD, SUITE 370, ALEXANDRIA, VA, 22314, US

(21) Appl. No.: 12/323,545

(22) Filed: Nov. 26, 2008

(30) Foreign Application Priority Data
Nov. 27, 2007 (JP) 2007-305198

(51) Int. Cl. G06F 15/16; H04L 9/32; G06F 21/00

(52) U.S. Cl. 713/171; 709/219; 726/10; 709/203

(57) ABSTRACT

A content delivery method, a control terminal for content delivery, and a display terminal for receiving content delivery. In a content delivery service, the control terminal for authentication and the display terminal for displaying and/or storing of content are separately provided to perform authentication and exchange of a key so as to select a content delivery destination from a server.

### INCORPORATION BY REFERENCE

The present application claims priority from Japanese patent application JP 2007-305198 filed on Nov. 27, 2007, the content of which is hereby incorporated by reference into this application.

### BACKGROUND OF THE INVENTION

1. Field of the Invention

The present invention relates to systems which are used to view content such as a video and more particularly, to a system which causes a plurality of devices to be linked to each other to view content via a network.

2. Description of the Related Art

Some of prior arts in the above technical field are enumerated. For example, JP-A-2004-336310 (Patent Document 1) recites “The object of the present invention is, upon terminal handover, to enable seamless and continuous view of a content so far viewed at the handover originator terminal again at a handover destination terminal without eliminating the need of newly logging in on the new terminal from the handover destination terminal (refer to paragraph number [0006] in the Patent Document 1). The object is attained by linking a system (MetaPORT) of seamlessly performing handover over the content to a view history management server conforming to the TV-Anytime Forum specifications, a content metaserver, a location solution server, a presence management server conforming to IETF specifications, and so on. The MetaPORT is a view continuous control server (MetaPORT server) which implements a suspend and resume function as a network service, that is, which causes a network to take over a context of the content so far viewed by the user at the handover originator terminal and to make the context to conform to the presence of the handover destination terminal for delivery and play. It provides such a user interface to the user that the user selects the handover originator/destination terminals on a display screen of the terminal (MetaPORT terminal) to instruct the handover, and the interface accesses the presence server and the location solution server according to the user's input to attain the handover function seamless to the handover destination terminal (refer to paragraph number [0008] in the Patent Document 1)”.

JP-A-2005-323068 (Patent Document 2) also recites “The object of the invention is to provide a home network AV server and a home network AV server program having a good handleability which, even when a user suspends a content view in a general home network environment, the user can resume the view from the suspended position, and also a home network AV server program (refer to paragraph number [0006] in the Patent Document 2). The object is attained by providing such a home network AV server as follows. That is, the AV server comprises a data transmission position detector which detects a current transmission position of the content data transmitted to a client terminal, and also comprises a content information creator which creates content information for start from a middle point corresponding to a played and stopped data position as a play resuming position on the basis of the current transmission position of the content data issued from the data transmission position detector and which stores the created data in a content information list memory. The transmission data creator, when the view play is resumed from the client terminal, transmits the content data from the play resuming position by referring to the middle start content information in the content information list memory (refer to paragraph number [0007] in the Patent Document 2).”

With respect to authentication of a transaction between devices, JP-A-2002-169719 (Patent Document 3) recites “The object of the invention is to provide a content delivery system which, in content transaction between user devices, performs personal authentication as user identifying operation to allow user use of the content. The object is attained by using, as a delivered content, a secure content which includes content encrypted with a content key and which also includes a secure content including container information having content transaction conditions set therein. The container information contains a personal identification certificate identifier list. In secondary content distribution between user devices after primary content distribution, use control information containing the list is generated and stored in the devices. During the content delivery between the devices, a personal information identification certificate is identified from the list, the user device executes personal authentication based on the personal identification certificate, and when the authentication is established, the transmission content can be used.”

### SUMMARY OF THE INVENTION

In the above Patent Documents 1 and 2, however, no consideration is paid to certification or authentication relating to content viewing when the viewing terminal is switched to another terminal for continuous view.

The Patent Document 3 teaches the fact that, with respect to primary distribution to a main terminal and to secondary distribution as copy or move from the main terminal to a sub terminal in content delivery, when the secondary distribution is carried out after user authentication, content secondary distribution is carried out between the devices (terminals) under conditions of personal authentication based on certificate by a reliable third party certification authority. In the Patent Document 3, however, it is required to first perform the primary distribution, that is, to distribute the content to the main device. Accordingly, in a streaming type of delivery of IP-TV (broadcast service for distributing a video content such as a television program or a movie according to the Internet Protocol), when the user wants to display the content at the sub terminal (not at the main terminal), it is required to temporarily store the content in the main terminal (device) or to once send the content to the main terminal and then to deliver the content to the sub terminal via the main terminal. To this end, it becomes necessary to solve problems with difficult immediate display, data congestion and an increased amount of processing operations caused by complex data path. In particular, in a commercial IP-TV service, many users do not have sufficient expertise about network connection, how to use the content delivery service and terminals or devices used in many cases. Therefore, it also becomes necessary to solve problems with unsatisfactory immediateness and with operability reduced by an increased amount of data or processing operation.

Similarly, since even only display at the sub terminal requires a storage means, it also involves another problem with an increased price caused by an increased capacity of the memory means in the terminal and by mounting of a portable memory device (such as a portable media drive such as DVD or memory). This problem seemingly becomes remarkable when content requires a high-resolution video or an enormous amount of long-time data.

In order to solve the above problems, in accordance with the present invention, there is provided a technique by which, in a content delivery service for an example, a terminal for authentication and a terminal for displaying and/or storing contents are separately provided for content view. In particular, the technique is implemented while minimizing an increased amount of processing operation or data congestion in a terminal and a network.

More specifically, a content delivery method using a network includes a step of informing a server of information about designation of a display terminal for content view from the control terminal and a step of delivering content from the server to the display terminal. The method may also include a step of transmitting user log-in information from the control terminal to the server, a step of transmitting certificate information from the server to the control terminal when the server recognized the user on the basis of the log-in information, and a step of transmitting the certificate information from the control terminal to a display device. The method may also include a step of transmitting the information for designation of the display terminal and the certificate information received from the control terminal from the display device to the server, a step of authenticating at the server (the information) on the basis of the display-terminal designation information and the certificate information received from the control terminal, a step of transmitting key information corresponding to the content from the server to the display terminal when the authentication is established, and a step of displaying the content at the display terminal using the key information.

With the above means, one terminal such as a portable terminal can execute the authentication, while the user can view the content on the other terminal such as a TV terminal having a relatively large display screen.

Other objects, features and advantages of the invention will become apparent from the following description of the embodiments of the invention taken in conjunction with the accompanying drawings.

### BRIEF DESCRIPTION OF THE DRAWINGS

FIG. 1 shows an exemplary configuration of a system;

FIG. 2 shows an example of a user authentication information (101);

FIG. 3 shows an example of device authentication information (102);

FIG. 4 shows another example of the device certication or authentication information (102);

FIG. 5 shows an example of charging information (104);

FIG. 6 shows an example of content information (105);

FIG. 7 shows an example of key information (109);

FIG. 8 shows an example of log-in information (111);

FIG. 9 shows an example of device information (121 or 141);

FIG. 10 shows examples of first processes in a server (100), a display terminal (120) and a control terminal (140);

FIG. 11 shows an example of a user certificate;

FIG. 12 shows an example of a display-terminal select display screen;

FIG. 13 shows an example of a content select display screen;

FIG. 14 shows an example of a decryption key; and

FIG. 15 shows examples of second processes in the server (100), the display terminal (120), and the control terminal (140).

### DETAILED DESCRIPTION OF THE EMBODIMENTS

Explanation will be made as to preferred examples (embodiments) of the present invention.

Though it is assumed in the embodiments that a broadcast service (which will be referred to as the IP-TV, hereinafter) is provided to deliver content such as program information about several media including video, sound and character information according to Internet Protocol; the present invention is not limited only to the illustrated example.

The IPTV service is roughly classified into three forms, that is, streaming, download and progressive download. In the streaming service, data about content is sequentially distributed from a server to a client, and the client in turn plays a video, a sound and so on from the received data to present it to the user. For this reason, the streaming service is featured in that, in the case of a network having a sufficiently broad band, the user can view the content substantially on a real time basis. In the download service, a client previously acquires all data about content from a server, stores the data, and after the storage of the data, plays the content to view. For this reason, the download service is featured in that, when it is unnecessary to view the content on a real-time basis, the user can view the content many times for a desired time by previously completing the distribution of all the content data and storing it and can receive content delivery even in the absence of a network having a sufficiently broad band. In the progressive download service, which is regarded as an intermediate between these two of the streaming and download services; prior to completion of full delivery of the content, viewing is carried out sequentially from the data stored in the terminal (a view time axis can be changed for fast-forward or fast-reverse view or a temporary stop, which is sometimes called “trick play”). Thus, the progressive download service has a merit that it is not necessarily required to wait for the completion of the content storage, a storage time can be shortened even when the band is not a sufficient broad, and the user can view the content many times at desired timing so long as it is after the storage completion.

In the content delivery service including the IPTV service, in general, users are, in many cases, charged by the internet service provider for their use fees in exchange for receiving the service. At this time, the users previously registered as correct or authorized users, and various types of information including passwords (which may be passcodes or biometrics information such as fingerprint), real names and addresses are managed on the basis of their identifiers (IDs) as indexes. On the basis of such information, it is confirmed that charging information when the user receives deliver of a pay content, stores and views it, can also be recorded, and the user can pay a use fee for the content by a separately specified paying method. When the user wants to use the content, the user is required to receive user authentication to receive the service by collating the identifier in these registered information with management information based on the password. A display screen for service selection called “portal” to select and search for a desired delivery content or to select a service such as other information deliver is, in many cases, provided to the authenticated or authorized user.

In many cases, further, device authentication is carried out. That is, whether or not a terminal device used by the user is a device specified by the service provider or whether or not a program for receiving a delivery service to be operated in the terminal device is a program specified by the service provider, is confirmed through communication prior to the delivery service. This device authentication prevents an illegal action such as illegal copy, move or modification, based on a statute such as a copyright. At this time, the content is previously encrypted in a common key encryption scheme, and a key for decrypting the encrypted content is separately sent to or received and held in an authenticated device to be linked to the content so that the authenticated authorized user can be decrypted on the authenticated authorized device. Further, a public key and a secret key in a public key encryption scheme may be prepared by the terminal side or by the service provider so that the secret key is sent to the terminal upon user registration to be used between the service provider and the terminal for encryption and decryption respectively. In general, these decrypting keys are recorded together with play conditions of content play expiration date and frequency, and playable users and devices. The encrypting key will be referred to as the encryption key, and the decrypting key is referred to as the decryption key, hereinafter.

In this way, on the basis of the user authentication, the device authentication and encryption key linking; the internet service provider, as an agent of content or service provider, provides a content delivery service or the like to users and reliably charges the users with their use fees. Thereafter, the user can receive delivery of a desired content and can correctly receive a service such as content play. Based on the above, the user can hold, in some cases, content linked to a user playable right.

Using the content thus obtained and the decryption key, the user plays the content, but the content and the decryption key are assumed to be used by the same terminal device and by the same user. Thus, when it is desired to play the content on another device, it is required in some way to copy or move the content and the decryption key.

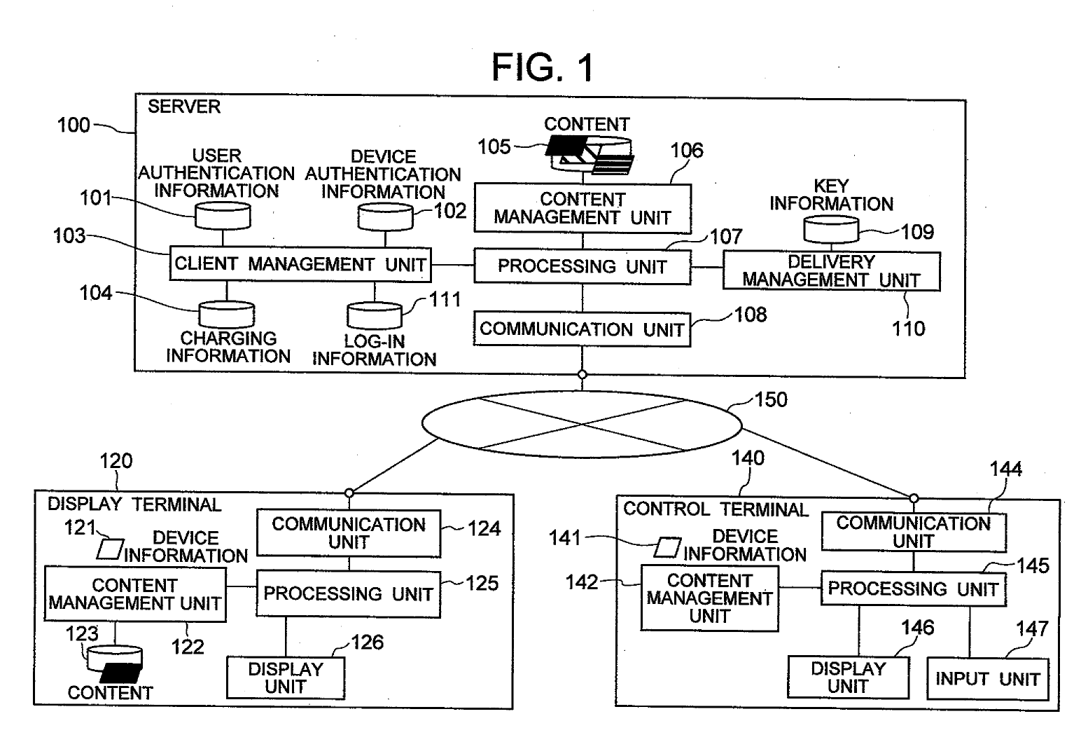

FIG. 1 is a block diagram of an exemplary arrangement of a system. A server (100), a display terminal (120), and a control terminal (140) are connected with the Internet (150) located in their center. The display terminal and the control terminal are connected to a home network by wired or wireless line to be connected to an external network such as a public network through a broadband router or another device.

As an example of use situation, it is considered that the control terminal (140) is, for example, a portable terminal such as a cellular phone or a PDA and that the display terminal (120) is, for example, a TV set located in a living room or a study room, the user operates the portable terminal to view a content on the TV.

The server (100) includes a communication unit (108) for communication with another device and in particular, with a client using a central processing unit (107) and using a network; a client management unit (103) for managing clients; a content management unit (106) for managing contents; and a delivery management unit (110) for managing the delivery condition. The server (100) is not provided always as a single device, but provided separately, for example, for each of the content and client management units.

In this case, a client management unit (103) manages user authentication information (101) for authenticating each user, device authentication information (102) for authenticating a device possessed by the user, charging information (104) having a content charge condition recorded therein, and log-in information (111) having a user logged in a server management space recorded therein.

Each management unit may be implemented by hardware or by software such as a program to be executed under control of a CPU or the like.

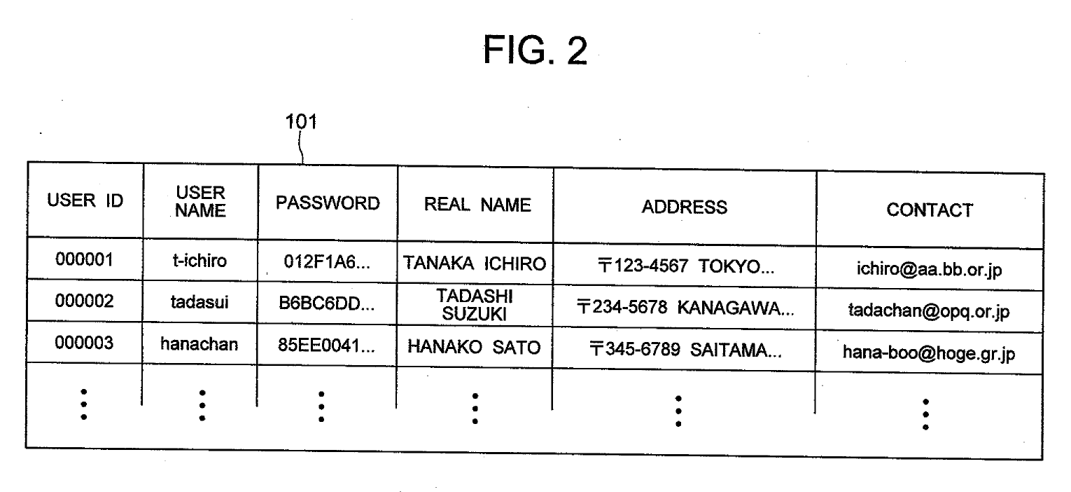

FIG. 2 is a data table showing an example of contents of the user authentication information (101). The authentication information to be managed by the client management unit (103) includes a user ID management number), a user name, a user password, user's real name, address, etc., unique to the user ID, In the present embodiment, explanation will be made assuming that user authentication is carried out based on password. However, user authentication may be carried out based on general biometrics authentication such as finger vein, fingerprint, voice, face image, or iris. In this case, items for the user authentication information are suitably varied.

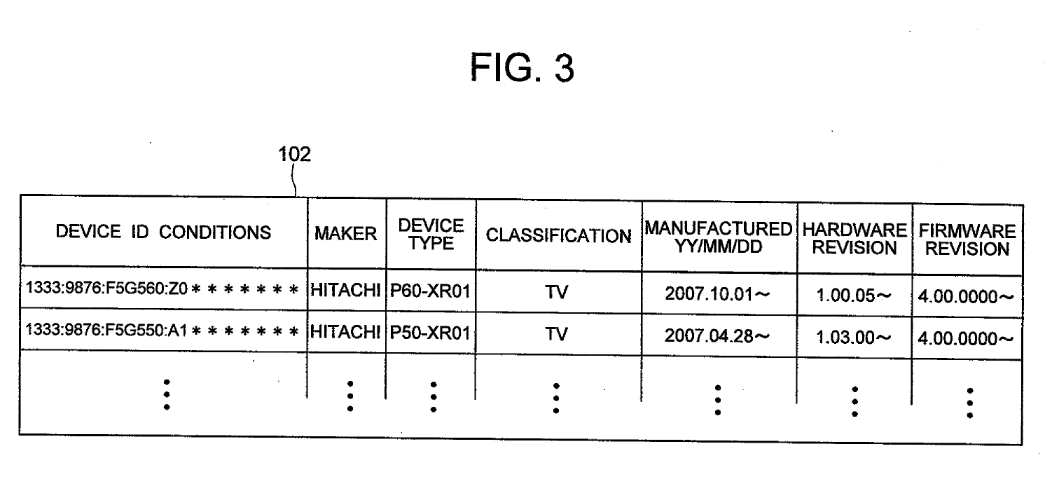

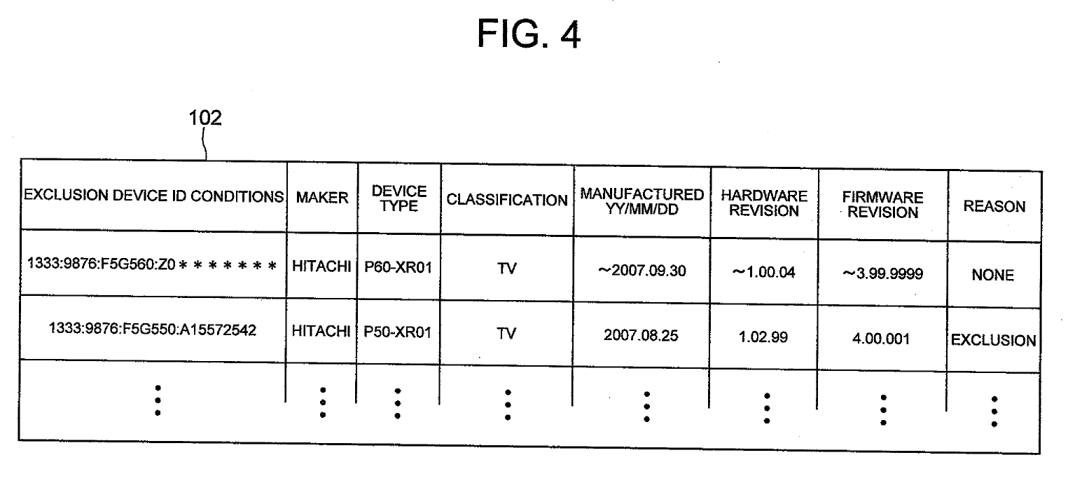

FIGS. 3 and 4 show data tables showing exemplary examples of device authentication information (102) respectively. FIG. 3 shows conditions of devices to be authenticated, and FIG. 4 shows conditions of devices not authenticated (conditions of rejecting the corresponding devices). One or both of FIGS. 3 and 4 may be used. The device authentication information to be managed by the client management unit (103) includes evaluation conditions as its contents, that is, a device ID, a manufacturer, a device type, a manufactured date, hardware revision number, a firmware revision number contained in the device information (121, 141) to be commonly used by users. In these contents, the device ID may be expressed by wild card to cope with a change in a digit as part of the device ID, a range of the manufactured date or year/month/day may be variably expressed, or specific one of the devices may be expressed in an exceptional requirement.

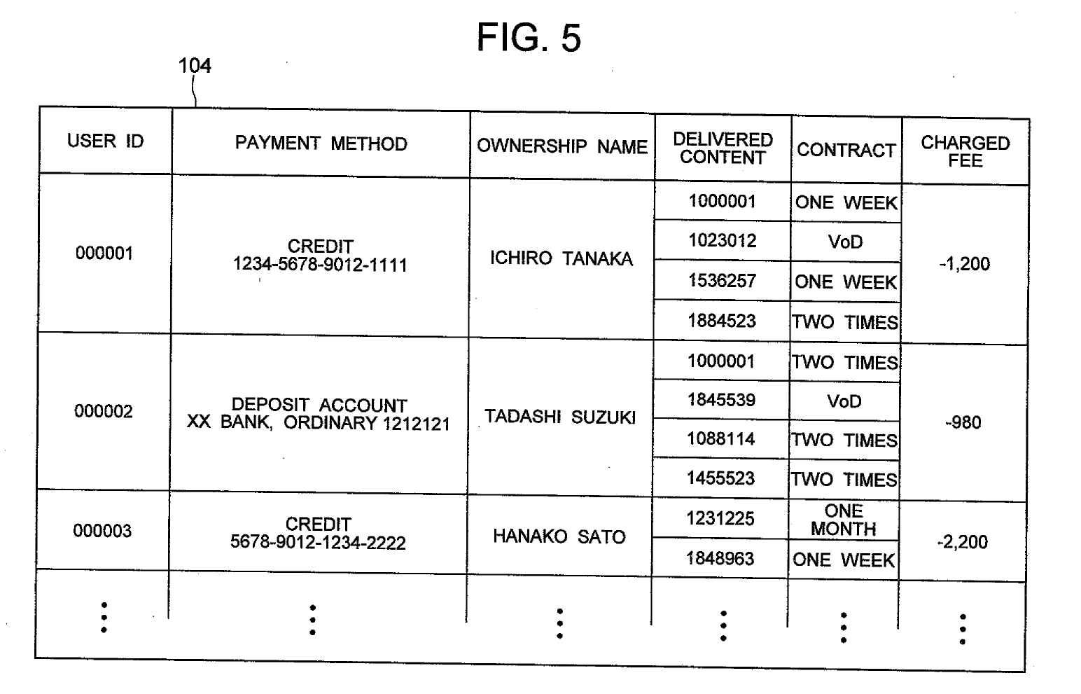

FIG. 5 is a data table showing an example of contents of the charging information (104). The charging information to be managed by the client management unit (103) records therein a payment method, an ownership name or holder, an already-delivered content ID, a content delivery method, a content contract term, and a fee charged to a client for the content delivery service or for the play or view of the delivered content, which are linked to the aforementioned user ID. In the content delivery method, “VoD” is recorded for a streaming type without storage, a term (period) or a download frequency (number of times) for download and progressive download types. In the Table, “−1” indicates no frequency limit.

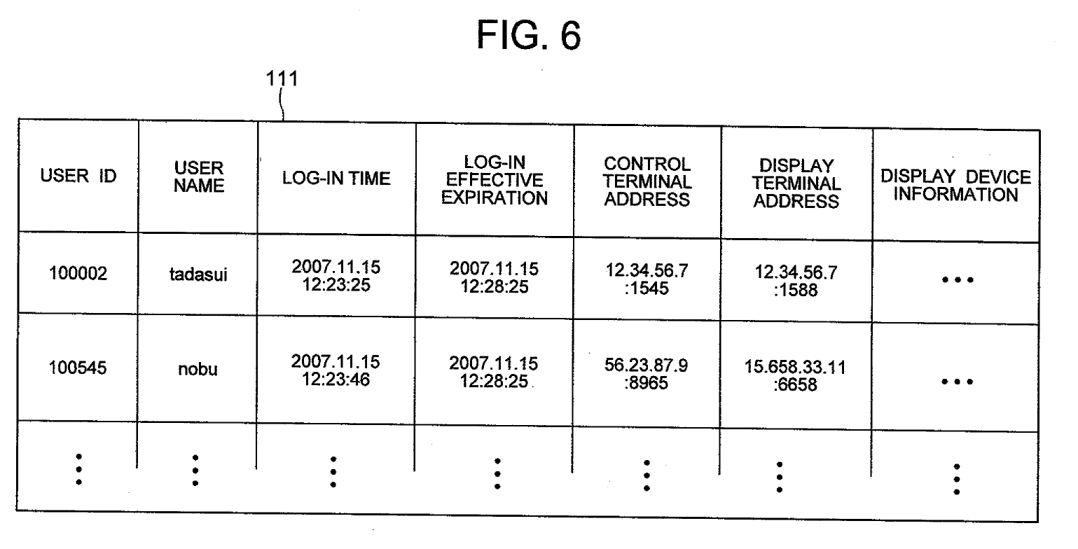

FIG. 6 is a data table showing an example of contents of the log-in information (111). The log-in information to be managed by the client management unit (103) is used to manage information about a user who logs in to receive a service at a time point. The log-in information has, when a user is recognized and logs in by performing a predetermined procedure, for example, by transmitting a user name and a password in the server management space as mentioned above; a user ID, a user name, a log-in time, a term, an address (port) on a network of the control terminal for the log-in or delivery control and of the display terminal for displaying the delivered content; and as device information about the display terminal, a content type, encoding scheme or resolution of a displayable content, and information about format such as a sampling rate. Using these information, the type of the delivering content or the format may be adjusted. The “log-in effective term” as used herein, when the user conducts no specific operation for a specific time, is used to release a processing resource for log-in or delivery to save the resource or to ask the user of reentry of the password to prevent illegal use of the content by a third party. The address of the control terminal may be the same as the address of the display terminal. When the display terminal is unknown, its address may be blank. In this case, the address of the display terminal is held by specifying the display terminal to be explained in delivery flow (to be explained later).

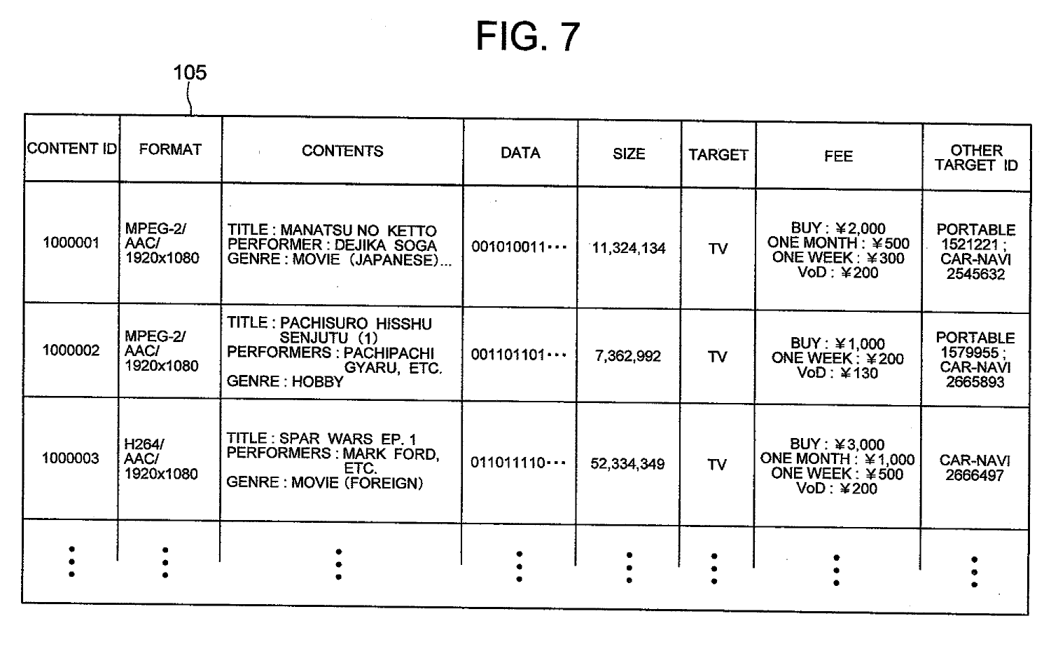

FIG. 7 is a data table showing an example of contents of the content information (105). The content management unit (106) manages the content information (105) including content data and information associated therewith. The content information records therein a content ID (management number), a content format, contents explanation information, content data, a content size, device target suitable for display, a fee for content delivery service or for play/view of the delivered content, an ID of a content with the same contents but a different display target. Such various sorts of information may be recorded in a recording medium such as a hard disk to be read out onto a memory managed by the content management unit. The information may be divided into several types including content data and data (metadata) for explaining the content data for management. For the purpose of protecting the content in a communication path of the Internet from a malicious third party, it is also desirable to manage key information to decrypt and play the encrypted content using an RSA encryption technique or the like. In this connection, such various sorts of information may be recorded in a recording medium such as a hard disk to be read out onto a memory managed by the client management unit (103).

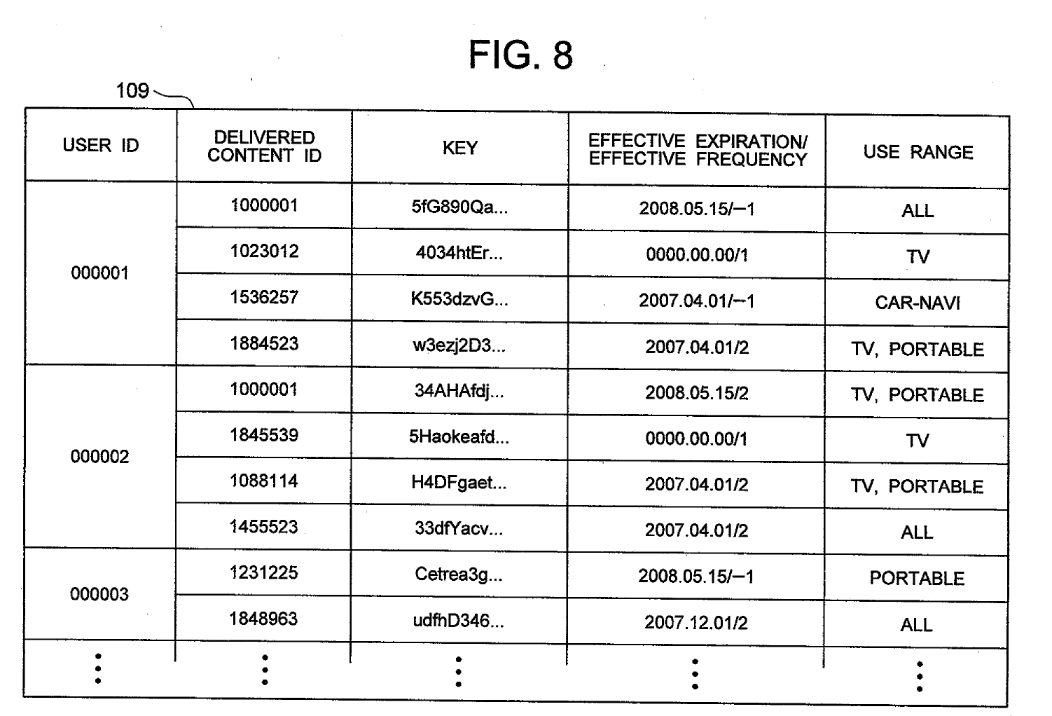

FIG. 8 is a data table showing an example of contents of the key information (109). The delivery management unit (110) manages information including a content ID and key data (if both of encryption and decryption keys are required, the both are desirable) for each content delivered for each user as key information, and including its use range in the presence of a device type or a requirement for content play.

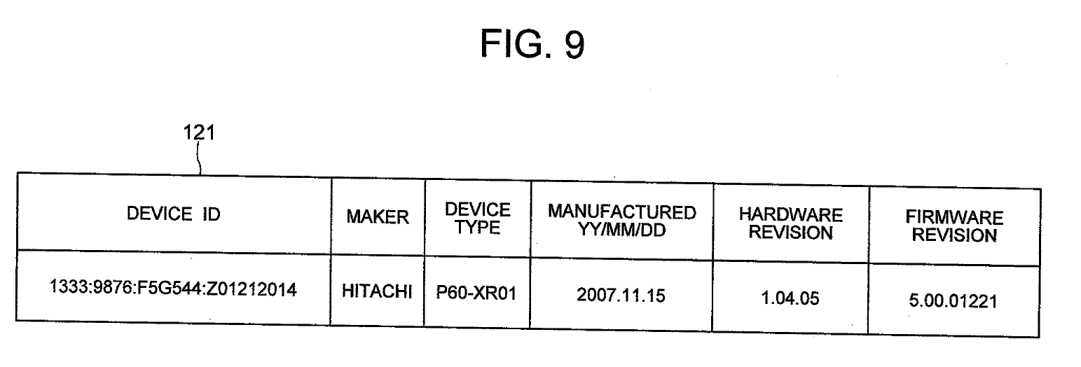

FIG. 9 is a data table showing an example of contents of the device information (121). The device information includes a device ID, a type name, and a manufactured date as information unique to the display terminal (120) for identifying the device; and also includes revision numbers or identifiers of hardware and software within the display terminal. Device authentication is carried out by transmitting these information to the server. Even the control terminal has also the device information (141). The device information is required to be held in the terminal by such a method not to be modified by the user as in a ROM (Read Only Memory).

### Embodiment 1

Explanation will next be made as to examples of operations of the server (100), the display terminal (120), and the control terminal (140).

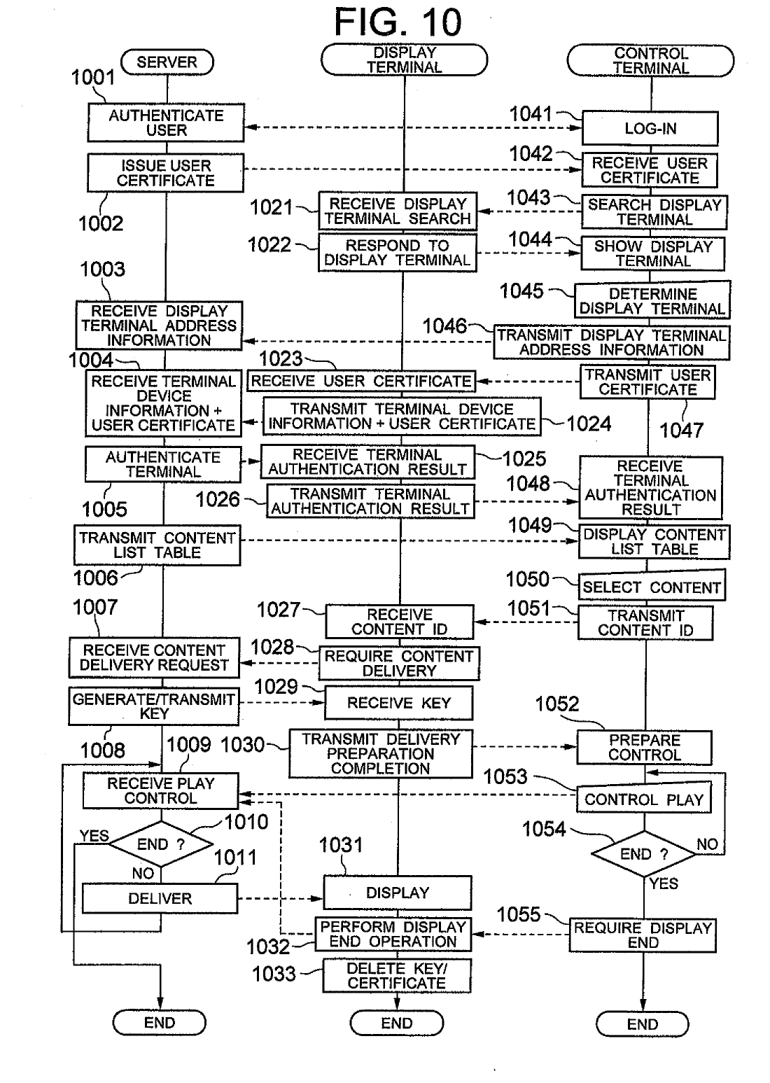

FIG. 10 is a flow chart showing examples of processing operations of the server (100), the display terminal (120), and the control terminal (140) in an embodiment 1. In the example of the processing flow chart, the control terminal performs log-in operation to acquire a user certificate based on the user authentication of the server, and transmits the acquired user certificate to the display terminal, and the display terminal in turn transfers the content decryption key between the display terminal and the server on the basis of the certificate and performs delivering and displaying operations. The respective processing operations will be explained according to a time axis. In this connection, it is assumed that the respective operations are carried out mainly by the server or by processors of the both terminals to be executed in cooperation with respective units connected thereto. Communication is carried out using the communication units via the Internet. This explanation is omitted for simplicity.

It is assumed that the server (100) already completes user registration so that the user can receive a content delivery service provided by the server. In this connection, it is also assumed that the user authentication information (101) such as a user name or a given password and the charging information (104) for paying a charge generated when the user receives the service are registered, and it is already recognized that the user has no inadequacy in using the service. It is further assumed that content data and its contents to be delivered as the service are separately registered already in the server as the content information (105). Another assumption is that conditions of an authorized terminal which can receive content delivery or conditions of a terminal excluded as a unauthorized terminal are managed as the device authentication information (102).

In the processing flow of FIG. 10, a user first accesses the server using the control terminal (140) and conducts log-in operation, that is, user authentication is carried out (steps 1001 and 1041).

In the user authentication, the user, for example, enters information including the user name, the password, etc. on a log-in display screen. A processing unit (145) in the control terminal transmits the entered information in a predetermined format to the server, and the server in turn receives the information. Using the user authentication information (101) (in FIG. 2) managed by the client management unit, the server verifies whether or not the obtained user name and password are correct. When the obtained information is correct, the server authenticates the user who correctly logged in to the server, and registers the log-in information (111) (see FIG. 6). The server records an address (IP address and port number) of the control terminal used when the user logged in, and also records the authenticated time point and a time added by a predetermined duration (such as 10 minutes) as a log-in expiration time. This is one of means for preventing a third party from conducting illegal operation while the user leaves the control terminal. Further, when the log-in time is expired, the user may again conduct the log-in operation. In this example, explanation has been made in connection with the user name and the password. However, authentication may be implemented by biometrics authentication using an image such as user's finger vein, fingerprint, iris or face or by other authentication means using a sound such as sound spectrogram. At this time, the server manages user authentication information for verifying this user information to authenticate the client. In this connection, the user authentication may be replaced with the device authentication of the control terminal, that is, with the authentication of the device information (141) of the control terminal delivered to the server by the server. The device information of the control terminal conforms to the device information (121) (see FIG. 9) of the display terminal, and explanation thereof is omitted.

In the next processing, after the log-in operation is completed, the server transmits data called user certificate to the control terminal (step 1002), and the control terminal in turn receives the data (step 1042).

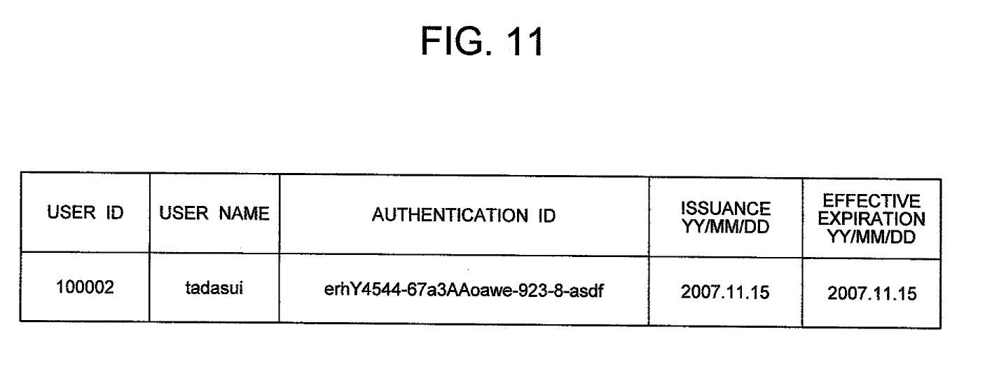

FIG. 11 is a diagram for explaining a user certificate. The user certificate certifies that the user was authenticated using the control terminal, and describes therein information which is used to cause the display terminal to ask content delivery of the server. The information is also called certificate information. The certificate information includes, for example, an authentication ID together with a user ID, a user name, an issuance date or year/month/day, an effective expiration date or year/month/day, and time information about the both. It is desirable that the authentication ID is generated by such an encryption technique as to use information dynamically varying according to the issued date, time or the user name as an index and so as to prevent easy forging of the authentication ID.

The control terminal next searches for a display terminal usable on the network. At this time, as defined by the general universal plug & play (UPnP) standard, a device searching technique based on a “discovery” function of finding one of devices connected to a home network which satisfies specific requirements as a display terminal may be employed. More specifically, according to a protocol called SSDP (Simple Service Discovery Protocol), the control terminal transmits a display-terminal inquiry request by broadcast communication to corresponding one of network display terminals of multicast communication from the display terminal (step 1043), the corresponding device, in particular, the display terminal of the present embodiment receives the inquiry request (step 1021), and transmits a response to it to the control terminal (step 1022). At this time, address information of each display terminal relating to the display function including a network address, a port number, and a title, is obtained. In this connection, responses from a plurality of devices may take place simultaneously. Even in this case, the control terminal receives the responses from all the devices and holds respective device information therein. Based on the responses, the control terminal displays the display terminals connected to the network on a display unit (146) for user presentation (step 1044). Although the display units (146, 126) are assumed to be each a liquid crystal type or an organic EL type, the display units may be each any output unit for outputting data to the display.

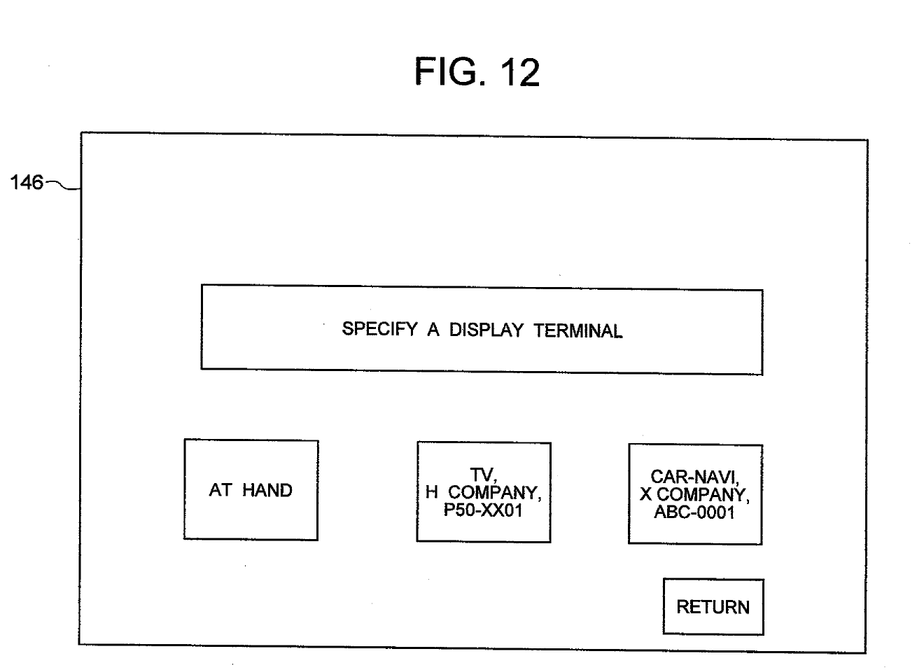

FIG. 12 is a diagram for explaining an example of a display-terminal select display screen displayed on the display unit of the control terminal. In this drawing, the control terminal itself can be selected as a bottom “at hand”. Simultaneously, “TV H company P50-XX01” and “car-navi X company ABC-0001” can be displayed in the form of buttons to be selected as candidates. That is, the buttons are displayed in the form of buttons on a user interface using an input unit (147). The user selects one of such display terminal candidates and the control terminal determines the selected display terminal (step 1045). Although explanation has been made in assumption that all the terminals can be connected to the home network, a similar device searching technique may be employed even for non-home network. Further, a specific device possessed by the user may be managed by a specific device on the network. For example, not multicast but unicast communication may be carried out by the server which manages these devices and previously specifies a device usable by the user. A display terminal may be specified by performing similar mutual communication on a device network based on the Internet, a wide area wireless network called a cellular phone network or WiMAX, or on a heterogeneous network such as IEEE1394 or Bluetooth.

The aforementioned address information obtained for the display terminal determined by the user in this way is transmitted from the control terminal to the server (step 1046), and the server in turn receives the address information (step 1003). In this connection, in this step, the display terminal may transmit the address information. In this case, a notification indicative of the display terminal determination is informed from the control terminal to the display terminal, and thereafter information on its own terminal is informed from the display terminal to the server. The step of informing of the information about the display terminal may be carried out at the same time as a next device authentication step.

The user certificate (see FIG. 11) already received from the control terminal is next transmitted to the display terminal (steps 1047 and 1023), and the display terminal transmits the user certificate and device information (121) (see FIG. 9) to the server (steps 1024 and 1004). The server can identify the fact that the display terminal is used together with the control terminal under control of the user on the basis of the user certificate. The server compares the terminal device information with the device authentication information (102) (see FIG. 3) managed by the client management unit (103) to confirm ability of the corresponding display terminal to deliver content functionally, and/or to confirm that the terminal is an authorized terminal, that is to perform terminal authentication (step 1005). The result is transmitted from the server to the display terminal (step 1025), and the result is further transmitted from the display terminal to the control terminal (steps 1025 and 1048). When the display terminal is correctly authenticated to perform the content delivery, the server transmits to the control a list of contents deliverable suitably to the display terminal among the content information (105) (see FIG. 7) managed by the content management unit (106) terminal (step 1006), and the control terminal in turn causes the list to be displayed on the display unit (146) (step 1049). In this connection, the above expression “contents deliverable suitably to the display terminal” may be selected according to an attribute such as TV or car navi included in the terminal device information or according to the format displayable by the display terminal, or may be selected or prioritized according to the previous registration of the user or to user's preference estimated in the server.

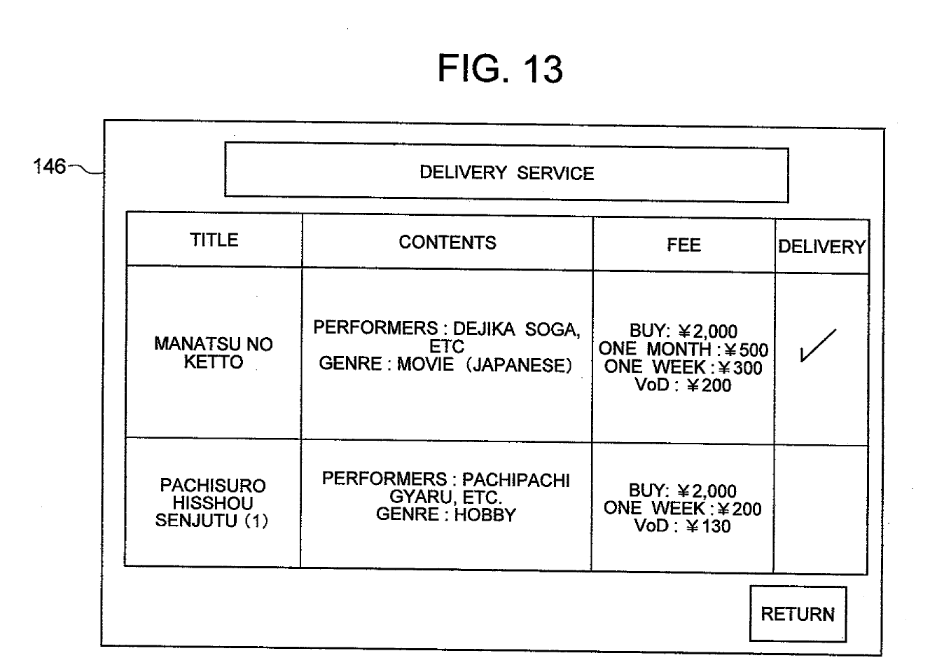

FIG. 13 shows an example of a content select display screen of a display unit of a control terminal. In the illustrated example, a tile, content's abstract, and fee for delivery are displayed in the form of a table on the display screen. Based on this displayed table, the user selects a desired content through the user interface using the input unit (147), and this causes the control terminal to acquire the corresponding content ID (step 1050). In the drawing, selection is made by the user who checks a desired delivery item field. In this connection, the select table may be displayed on the display unit (126) of the display terminal, and the user may select on the display terminal.

The ID of the content thus selected is transmitted from the control terminal to the display terminal (steps 1051 and 1027), and the display terminal issues a content delivery request to the server using the received content ID (steps 1028 and 1007). The content delivery request may be transmitted from the control terminal directly to the server not via the display terminal.

The server then generates a decryption key for the content or acquires it from the existing data, and transmits the decryption key to the display terminal (steps 1008 and 1029).

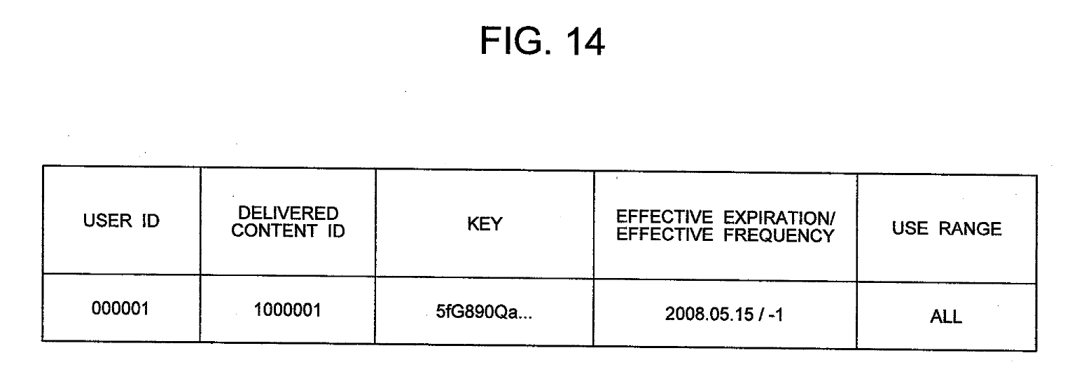

FIG. 14 is a diagram for explaining an example of a server key. In this example, the server key includes data about a user ID, a content ID, an effective expiration date or effective frequency, and a use range, in addition to information on the decryption key. The server key is also referred to as key information. When delivery conditions such as the effective expiration date or effective frequency are present, the display terminal may determine whether or not the content can be delivered. In the example of FIG. 14, the effective frequency is “−1”, this means that the effective frequency is limitless. However, the delivery conditions may be limited or be expressed in the form of another representation. In this connection, the step of transmitting the decryption key is provided when the content is required to be encrypted. Thus when it is necessary to the content, this step can be eliminated.

When the display terminal satisfies the decryption key and the delivery conditions and completes preparation of the delivery, the display terminal transmits a notification indicative of the completion of the delivery preparation to the control terminal (step 1030), and the control terminal in turn causes a user interface for delivery control to be displayed on the display unit (146) or waits for a user operation from the input unit (147) (step 1052).

When the user inputs content play control such as play, temporary stop, fast forward, or quick reverse using the control terminal; the control terminal transmits the control information to the server (steps 1053 and 1009). When the control information is other than the end (stop) (step 1010), the server delivers the content to the display terminal (step 1011), the display terminal in turn receives the content. In the present the decryption key, the display terminal decrypts the content using the decryption key, and displays the content on the display unit (126) of the display terminal (step 1031). When the user operation is the end (stop) (step 1054), the control terminal transmits a display end request to the server via the display terminal or the like (steps 1055, 1032, and 1009), and the server in turn terminates the content delivery (step 1010) and terminates the session relating to the content delivery. When the decryption key or the certificate is unnecessary at the display terminal, the decryption key or the certificate may be eliminated (step 1033), that is to prevent user from playing illegally.

When the user again requires delivery of the same content, steps associated with transmission of the user certificate or of the decryption key may be omitted and the content delivery step may be carried out. In the content delivery, further, the display on the display terminal may be replaced with recording (123) or downloading of the content by a content management unit (122) of the display terminal (120) or with sequential display or progressive downloading of the recorded content.

### Embodiment 2

Another example (embodiment 2) of operations of the server (100), the display terminal (120), and the control terminal (140) will be explained.

In the embodiment 1, the control terminal receives the user certificate and sends it to the display terminal, and thereafter the display terminal performs the terminal authentication through direct transaction with the server. In the embodiment 2, the control terminal performs transaction with the server without intervention of the user certificate, that is, the control terminal performs the terminal authentication and key transfer. However, a key for use in the display is transmitted to the display terminal, and the delivery itself is performed to the display terminal as in the embodiment 1. With it, the embodiment 2 can be implemented with the cost of the display terminal smaller than in the embodiment 1. In other words, it is assumed in the embodiment 1 that the servers performs independent authentication on the devices, that is, the server directly performs the device authentication with the display terminal; whereas, it is assumed in the embodiment 2 that the control terminal performs the authentication to omit the authenticating operation of the display terminal.

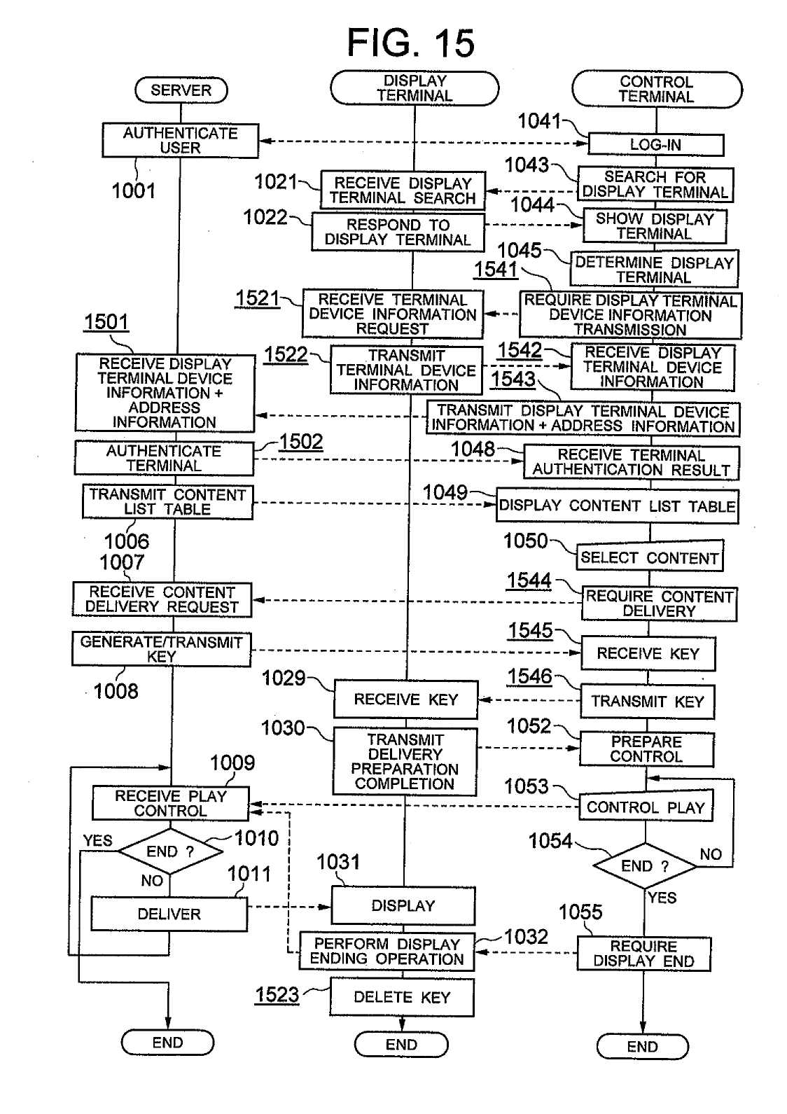

FIG. 15 is a flow chart showing an example of processing operations of the server (100), the display terminal (120), and the control terminal (140) in the embodiment 2. In the example of the processing flow, the control terminal performs log-in operation, and the control terminal performs device authentication on the display terminal from the server using information about the display terminal. Further, transfer of a content decryption key from the server is carried out under control of the control terminal, and then the control terminal transmits the decryption key to the display terminal. The content is transmitted directly to the display terminal, and the display terminal performs displaying operation. Explanation will be made according to a time axis for each processing operation. The same steps as in those in FIG. 10 are denoted by the same reference numerals and explanation thereof is omitted.

Steps until the step 1045 are the same as those in FIG. 10.

The display terminal (120) transmits the device information (121) about the display terminal (120) via the control terminal (140) to the server (100) to cause the server to perform device authentication. That is, the control terminal issues a device information transmission request to the display terminal determined by the user, and the display terminal in turn receives the request (steps 1541 and 1521). The display terminal transmits the device information (121) (see FIG. 9) of its own terminal to the control terminal, and the control terminal in turn receives the device information (steps 1522 and 1542). Thereafter, the control terminal transmits the obtained device information about the display terminal and address information about the display terminal obtained in the aforementioned manner to the server, and the server in turn receives the device and address information (steps 1543 and 1501). As in the embodiment 1, the device information may be delivered from the display terminal directly to the server. At this time, the device information may also be delivered to the server in response to the device information delivery request from the control terminal to the display terminal.

In a step 1502, unlike the step 1005 in FIG. 10, the server (100) performs no authentication using the user certificate, performs authentication over the display terminal (120) on the basis of the device information (121) (see FIG. 9) obtained from the control terminal (140), and transmits the authenticated result to the control terminal (steps 1502 and 1048). When the device information is sent from the display terminal to the server in the aforementioned manner, the authenticate result from the server may be sent to the display terminal, and the result may be transmitted to the control terminal, as in the embodiment 1.

In a step 1544, unlike the step 1028 in FIG. 10, the control terminal transmits a content delivery request using the selected content ID to the server (step 1544).

In a step 1545, unlike FIG. 10, the control terminal (140) acquires a decryption key (step 1545). And the control terminal transmits the decryption key to the display terminal (step 1546). In this connection, the server may transmit the decryption key directly to the display terminal.

The decryption key, if the key becomes unnecessary at the display terminal, may be removed (step 1523) to prevent user from playing illegally.

It is desirable that various sorts of information including the identifier, tables, etc. already explained above be stored by a suitable means such as encryption or self destruction upon abnormality in order to avoid illegal use such as external use by stealth or impersonation. It is also desirable that mutual communication between the communication unit of the server and the communication unit of the terminal be carried out based on data encryption to establish mutual reliability and to prevent external illegal use by another technique such as an SSL (Secure Socket Layer) technique.

The content used in the explanation of the present embodiments is assumed to be program information constituted by several media such as video, sound and character information. However, the content is not limited to such a content as mentioned above, and may be a file, executable object data, a mail, a markup description or a script for operational description sent or received by WWW (World Wide Web) for use in a PC (Personal Computer) or the like, and general electronic data transmitted through a network. Thus, the content can be applied to general use in many industries using networks, finding a great feasibility.

In addition, the server, the display terminal, and the control terminal may be partly implemented in the form of a processing program as software using a PC.

It should be further understood by those skilled in the art that although the foregoing description has been made on embodiments of the invention, the invention is not limited thereto and various changes and modifications may be made without departing from the spirit of the invention and the scope of the appended claims.

1. A content delivery method using a network, comprising the steps of:
notifying information from a control terminal to a server to specify a display terminal for view of a content; and
delivering the content from the server to the display terminal.

2. A content delivery method according to claim 1, further comprising the steps of:
transmitting log-in information about a user from the control terminal to the server;
when the server authenticates the user on the basis of the log-in information, transmitting certificate information from the server to the control terminal; and
transmitting the certificate information from the control terminal to the display terminal.

3. A content delivery method according to claim 2, further comprising the steps of:
transmitting information specifying the display terminal and the certificate information received from the control terminal from the display terminal to the server;
authenticating the display terminal at the server on the basis of the information specifying the display terminal and the certificate information received from the control terminal;
when the authentication is established, transmitting key information corresponding to the content from the server to the display terminal; and
displaying the content using the key information on the display terminal.

4. A content delivery method according to claim 1, further comprising the steps of:
authenticating the display terminal at the server;
when the authentication is established, transmitting key information corresponding to the content from the server to the display terminal; and
displaying the content using the key information on the display terminal.

5. A content delivery method according to claim 1, further comprising the steps of:
authenticating the control terminal at the server;
when the authentication is established, transmitting key information corresponding to the content from the server to the control terminal;
transmitting the key information from the control terminal to the display terminal; and
displaying the content using the key information on the display terminal.

6. A content delivery method according to claim 1, further comprising the step of:
issuing a content delivery request from the display terminal to the server.

7. A content delivery method according to claim 1, further comprising the step of:
issuing a content delivery request from the control terminal to the server.

8. A content delivery method according to claim 1, further comprising the steps of:
displaying a list of a plurality of contents on the display terminal; and
transmitting information specifying a content from the display terminal to the server.

9. A content delivery method according to claim 1, further comprising the steps of:
displaying a list of a plurality of contents at the control terminal; and
transmitting information specifying a content from the control terminal to the server.

10. A control terminal for content delivery, comprising:
an input unit for receiving an entry of authentication information from a user;
a communication unit for transmitting the authentication information and information about a display terminal for viewing of a content to a server and for receiving certificate information from the server; and
a processing unit for transmitting the received certificate information through the communication unit to the display terminal.

11. A control terminal for content delivery comprising:
an input unit for receiving an entry of authentication information from a user;
a communication unit for transmitting the authentication information, information about the control terminal, and information about a display terminal for viewing of a content to a server and for receiving key information from the server; and
a processing unit for transmitting the received key information to the display terminal through the communication unit.

12. A display terminal for receiving content delivery, comprising:
a communication unit for transmitting information about the display terminal to a control terminal and for receiving certificate information from the control terminal; and
a processing unit for transmitting the received certificate information and the information about the display terminal through the communication unit to the server.

13. A display terminal for receiving content delivery, comprising:
a communication unit for transmitting information about the display terminal to a control terminal and for receiving key information from the control terminal; and
displaying a content using the information received at the communication unit.

14. A content delivery method to be executed by a server, comprising the steps of:
transmitting authentication information from a control terminal;
transmitting certificate information based on the received certificate information to the control terminal;
receiving the certificate information from a display terminal; and
transmitting a content to the display terminal.

15. A content delivery method to be executed by a server, comprising:
transmitting authentication information and information about a display terminal from a control terminal;
transmitting key information based on the received authentication information and the information about the display terminal to the control terminal; and
transmitting a content to the display terminal.
